(19) United States
(12) Patent Application Publication
(10) Pub. No.: US 2014/0365234 A1
(43) Pub. Date: Dec. 11, 2014

(54) Computer Network-Interfaced Method for Health Care Provider Active Reach Into Diverse Sub-Population Communities

(71) Applicant: William Richard Saunders, Blacksburg, VA (US)

(72) Inventor: William Richard Saunders, Blacksburg, VA (US)

(73) Assignee: COMMUNITY PURSUITS, INCORPORATED, Blacksburg, VA (US)

(21) Appl. No.: 13/914,741

(22) Filed: Jun. 11, 2013

(51) Int. Cl. G06F 19/00

(52) U.S. Cl. CPC G06F 19/3418
USPC 705/2

(57) ABSTRACT

A computer network-interfaced method for public health and health care provider active reach into diverse sub-population communities for the purpose of reducing health care treatment gaps of the population-at-large; comprising a network of computing means for health care provider administrators, a network-interfaced web software registration process requiring member user characteristics and health insurance information to parse members into sub-population communities; provider secure remote access control of network-interfaced computing means of sub-population community members during scheduled consultations, and production, broadcast and storage of protocol-driven life-episodes for actively screening member health care needs and improving social inclusion of sub-population community members.

### CROSS-REFERENCE TO RELATED APPLICATIONS

This application claims the benefit of the filing date of U.S. Provisional Patent Application No. 61/658,948 filed Jun. 13, 2012, the disclosure of which is hereby incorporated herein by reference.

### BACKGROUND

The growing use of advanced technologies, most particularly in the related areas of information technology, communications, and computing has led to new opportunities for innovation in any number of professional disciplines. For example, the field of health information technologies is now widely recognized to provide increased efficiencies, cost-savings, and patient services for many different medical practices. One area of advanced health care technologies that needs further improvement is the interaction of health care provider networks, or private practitioner health care providers, to actively reach out to a diversity of underserved sub-populations. It has been standard practice that the delivery of medical care is typically conducted in a framework wherein a person with health care needs seeks out a health care provider for services, on occasions when that person has a health care need. This is considered to be a “passive” health care approach in terms of the health care providers' efforts to offer needed health care services to a community. Though there are outreach strategies in health care, there is opportunity for improvement with advanced technologies. It is now well known that there are underserved communities in regards to the availability of adequate health care, for a variety of reasons. Therefore, it is a further aspect of this invention to actively overcome certain well-known treatment gaps in specific areas of health care. The method here proposes a network-interfaced computing means to enable health care providers who wish to actively reach out to entire sub-populations in the quest to make many forms of health care more accessible to many. An “active” health care approach is where health care providers seek out members of the population-at-large for the purpose of various forms of health care screening and treatment. It is a further goal of this invention to provide technology means that will increase the utilization of public health experts who have expertise to assist in the networking between sub-population communities and health care providers to overcome known barriers to health care.

The sub-population communities of this invention are distinct from any social networks in existence today. There are no social networks that offer its members continuous network access to human health care providers using the network-interfaced computing means as described for this method. The sub-population communities of this invention are also distinct from prior social networks in certain key attributes of the method, both in terms of network topologies for the proposed sub-population communities and in the web-software step of the method to support those communities. The attributes of the sub-population communities of this method are unique and necessarily include all of the following in order to achieve the goals of the method: health care provider registration of members into a specific, limited-membership (i.e. a closed membership), and a networked community with secure remote access links between providers and members, called a sub-population community, based on: a choice of boundaries that may include geographical, cultural, linguistic, or shared interests, or share corporate employment or share employment at a government agency; and provision of health insurance information as an essential registration step for the sub-population community; and health-care provider facilitation of information sharing within a specific sub-population community for the purpose of further facilitating a sense of community with the network; and the method step of providing networking software that can overcome deficiencies in technology skills that are still prevalent in many potential beneficiaries of this type of network-interfaced health-care related sub-population community. The benefits of this method are many. For example, a sub-population community may be created by a health care provider in such a way that the community is comprised of an entire neighborhood or all citizens of a small rural town. A sub-population community may be a number of Spanish-speaking households geographically separated by hundreds of miles. A sub-population community may be a number of immigrant families of a particular country of origin. A sub-population community may be akin to an online clinical practice where the members of that community are the entire patient listing of a specific health care provider or bundled health care providers.

This method is concerned with the access of health care providers to underserved sub-populations using computer network topologies that offer highly secure interfaces in order to mitigate the obstacles of central server security risks and privacy concerns for health care interactions between patients and providers. This method also offers new means for overcoming a current challenge to online health care treatment that is related to a deficiency in technology skills of many members of underserved sub-populations. This invention also offers new means for actively reducing the treatment gap for certain areas of health care, including mental health care and public health concerns. It will be shown that the method disclosed here simultaneously offers innovative solutions to all of these concerns.

The concept of underserved communities in the sector of health care takes on different interpretations depending on the type of health care. For example, a physician and a mental health (MH) provider have some shared goals; however, their primary provider roles are essentially different. A physician is primarily concerned with treating patients for physical health and a MH provider is concerned with mental health treatment. Though each provider may refer a patient to the other, their daily health care services and treatment methods are unique and distinct. Therefore, it is logical that a specific physical community that has access to a physician may not have access to a MH provider, and less often, the situation may be reversed. It is also obvious that there are distinctions in the treatment gaps and barriers for physical health and mental health; even though some of the barriers may be common to both. For example, MH care is known to face a challenge known as a stigma barrier to MH treatment. A stigma barrier can be described as certain individuals who feel that the need for MH care may be perceived as a weakness and therefore will avoid treatment. This issue rarely arises for physical health care. It is a further known issue to discuss an evidence-based treatment gap, wherein the use of evidence-based treatments are shown to provide the desired efficacy of health care. This method facilitates closure of the evidence-based treatment gap because of the human health care provider(s) who act in integral ways with the described method. Therefore, it is obvious that the delivery of health care technologies can be improved by the creation of sub-population communities that are created and serviced in ways that seek to reduce any health care treatment gaps based on the type of health care needs of a particular sub-population. It is obvious to those in the health care profession that bundled care or provider networks, which consist of multiple health care specialists in the same grouping, may also be effective in working with the sub-population communities described in this method. This would transfer the concept of ‘colocated health care’ to a sub-population community and is an obvious way to implement this method.

One common problem with certain underserved sub-populations, no matter the specific health care practice, is related to a deficiency in technology skills of the members of said sub-population. For example, it may be that members of a rural sub-population do have computing means but they are not capable of certain skills such as installation of new software applications onto their computing means or possibly do not understand web navigation well enough to be proficient at certain tasks. Therefore, one aspect of this method is to ensure that a network-interface between a provider computing means and a sub-population community member's computing means can be securely established so that remote assistance can be provided to the member who may be deficient in technical skills for certain operations with their computing means. This may require remote installation of application software onto the member's computing platform or may require remote assistance to operate certain application software elements on the member's computer as those applications may pertain to the provider interaction. For example, the use of video conferencing applications may prove beneficial between the health care provider and the member. That will only be possible if the member is skilled sufficiently to install and operate the application. Therefore, it is an innovative step of this method to engage a network-interfaced health care provider to a sub-population community wherein a provider administrator can easily and routinely user secure remote access means with a member's computing means in order to eliminate the technology skills network-interfacing health care treatment gap.

A further background challenge to network delivery of health care services is caused by security concerns. The secure remote access element to this form of closed-registration sub-population community will also mitigate certain security risks that exist when all members interface to a single central server hosting application software and member or provider data. The topology of the method for this invention will be described to minimize security risks, using secure remote access between provider and member, associated with transferring data or data files from sub-population community members' computing means to a central network server or to a provider computing means. In addition, the topology of the proposed network for the sub-population communities of this invention can serve to minimize technology platform costs that are currently a significant cost barrier to providing networked, or online, health care provider services to underserved communities. For example, as mentioned above, secure remote access can be used to ensure that all sub-population community member computing means can be successfully installed with free videoconferencing software, regardless of the technology skills of the member. In another form, a virtual desktop scenario can be employed as the secure remote access means of the method.

Therefore, this invention is focused on the active delivery of health care services to the population at large, especially to those who are currently considered to be underserved by any definition. In physical health care, most citizens in the public-at-large have some access to a medical physician. Since many barriers to mental health treatment are unique, as compared to physical health, the mental health treatment gap may be much higher. Two different estimates of the mental health care treatment gap in any given year place the number between 11 and 75 million persons (“Behavioral Health: Can Primary Care Help Meet the Growing Need?”, Alliance for Health Reform webcast, May 4, 2012; “Rebooting Psychotherapy Research and Practice to Reduce the Burden of Mental Illness,” Kazdin, et al., Perspective on Psychological Science 6(1), pp 21-37, 2011) Thus it can be argued that the MH providers simply must develop means to actively reach out to those underserved persons and this method offers an active reach into provider administered sub-population communities with a design intended to mitigate known treatment gaps.

The practice of health care delivery has evolved over the past two decades towards a prevailing model that moved away from a single health care provider ‘practice’ to a bundled health care delivery model. The bundled health care delivery model typically is owned and managed by large corporations. The bundled health care team will include physicians with different specialties, physician assistants, nurse practitioners and other health care providers which may or may not include mental health care providers. At this time, there are still numerous examples of mental health care providers in a single mental health care practice, distinct from physical health care treatment. In addition, there is still a strong precedence for sole proprietorship models for MH providers. While it may be that bundled health care practice will eventually dominate the marketplace, this invention is intended to facilitate network-interfaced provider and sub-population communities for any type of health care corporate structure, from bundled practices to sole proprietorships.

The network-interfaced provider and sub-population community method described here can serve for many forms of health care delivery. However, the active reach of this invention into the population-at-large is opposed to the more traditional model where potential patients seek out providers. Therefore, the expertise of public health (PH) experts in areas of community health must be inextricably linked with this active reach into populations-at-large. Said otherwise, the role of PH experts in this method is essential. This is not in the prior art for any health related social networks. This is accomplished in this invention by placing PH experts as at least one of the administrators of sub-population community registration step of the method.

Given that the MH treatment gap estimates are somewhere between 11 million and 75 million people, it is mandatory that the sub-populations must be registered from a subset of people comprising the population-at-large who may not be receiving necessary mental health care for any variety of known barriers to treatment. It is further understood that the ability of the MH provider to interact with those members must be such that treatment needs can be assessed. This method provides such means of interaction for the purpose of assessing MH treatment needs and other health care needs. Next, some further background on MH provider prior art in this area is reviewed.

The auspices of public health and mental health services are separate in the most literal sense. However, it is well understood by PH and MH practitioners that the public health of any population (or sub-population) is obviously coupled to the physical and mental health of all individuals comprising the sub-population(s) of interest. This method generally relates to the mental health concerns and goals that PH and MH providers have for sub-populations that are intrinsically linked by shared cultural, geographical, socio-economic, or other metrics that can be used to describe a particular sub-population of interest. The use of advanced technology, as described in this invention, will serve to provide PH and MH practitioners with new means of reaching underserved sub-populations, who may need MH assessment, evaluation, treatment, and education as described as in the embodiments described below.

Earlier inventors have described various methods and systems that attempt to improve upon legacy health provider practices using a variety of advanced technology means. Many of the inventions rely on computer analysis of data for assessments of various health characteristics. Shaw (U.S. Pat. No. 8,160,867) described computerized psychological content analysis of computer and media generated communications for a variety of objectives. Anson's invention (U.S. Pat. No. 8,147,251) describes a user's interaction with relevant icons that permits the computer to gather data to permit psychological diagnosis and treatment. Heidel (U.S. Pat. No. 8,069,061) describes a computer software program that will allow mental health practitioners to enter data into portable files and send information to various professional organizations in a very efficient manner. Schoenberg's invention (U.S. Pat. No. 7,865,377) connects a consumer of services with a service provider based on matching requested attributes with provider attributes stored in a computer database, followed by a connection between the consumer and the provider. Brown (U.S. Pat. No. 7,831,444) described a remote health management system comprised of a central computer connected to a series of remote computers, wherein the central computer conducts a variety of algorithmic steps, finally resulting in said treatment recommendation being provided from the central computer to a health care provider through said healthcare provider computer. Friedlander (U.S. Pat. No. 7,792,776) also utilizes a computer implemented system and method to aid in the identification of individuals and groups with a probability of being distressed or disturbed using a database of information stored on the computer. Ware (U.S. Pat. No. 7,765,113) describes another computer based system for assessing the health status or health care of a patient using a customized test protocol. Azzaro (U.S. Pat. No. 7,540,841) describes a system for monitoring the daily activity of an individual, where said system stores and processes the monitoring data for the purpose of assessing the mental health of the individual, and includes a device for providing a treatment plan for the individual. O'Hanlon (U.S. Pat. No. 7,246,069) describes a central database of health indicators, accessible via internet, that can include physiological and mental health data periodically provided by users, and used for generating health statistics or describing preventative treatment from analysis of said database. Joao (U.S. Pat. No. 5,961,332) describes an apparatus for processing psychological data, and said apparatus can process a treatment plan and be accessed remotely by a provider of services. Finally, Brown (U.S. Pat. No. 5,897,493) describes a centralized computer system comprised of a server and workstation that generates a script to deliver queries to a remote user for the sake of gathering information that might include mental health status data.

Several other inventors have described methods or systems related to PH or MH practices as they relate to multiple patients at once, or sociometric classifications of a sub-population of school children, or extraction of voice features for indication of mental stress. Brown (U.S. Pat. No. 7,769,605) describes collecting periodic sets of measurements from multiple users that are compared against a control variable for each user, respectively, thereby leading to supervisory instructions for the user. DeRosier (U.S. Pat. No. 7,330,823) describes the use of software to collect and categorize the sociometric classifications of school children for public health purposes. Monchi (U.S. Pat. No. 7,315,821) describes recording voice data responses from a recipient of specific questions, and using acoustic analysis to characterize a description of the recipient's mental condition based on the analysis. Brown (U.S. Pat. No. 6,527,712) describes a personal health monitoring system that monitors a current health profile including physical parameters and environmental parameters indicative of the current health of one of multiple users, such that health affecting factors of public health are audited.

More recently, inventors have begun to describe other features of advanced technology means as they may be related to the fields of either MH or PH which are the intended beneficiaries of this invention. A brief summary of published US patent applications will show that there is no prior art pending that considers the inventive means of the embodiments of this inventive method, described in the later sections.

Shaw (US Patent Application 2012 0084088) describes a computer-mediated communication produced or received by an author wherein said communication is analyzed by the computer to identify a psychological state, attitude or characteristic, especially in reference to a reference sample of psychological state, etc. Recent popularity of mobile communication devices has led to claims of innovation, as well. Hwang (US Patent Application 2012 0092171) describes a mobile device that is used to record and analyze a user's sleep state and alert the user to any sleep disorders. Collier (US Patent Application 2011 0125844) proposes a mobile-enabled social network application to support closed, moderated group interactions between registered users of the network for the purpose of enhancing the social resources of users who are under medical care and for facilitating therapeutic care. The network support of the application is said to provide means for storing communication data and analyzed for medical purposes, then transmitted to other users, possibly caregivers, based on the computer analysis of said data. Dhumne (US Patent Application 2011 0118555) describes a system where patients are in constant communication with one or more healthcare professionals on a wireless network and transmit the results of executable programs to the professionals. The professionals then analyze the results to make clinical assessments of the patients' mental health status. Other proposed inventions have also focused on the relatively new prevalence of social networks and applied them to user health objectives. Metzler (US Patent Application 2011 0047508) describes a proposed invention that combines a recovery-based social network group with automated analyses of recorded dialogue for the purpose of determining possible need for additional support by health care providers. Armstrong (US Patent Application 2006 0229914) submits a proposed invention that describes network-based monitoring of persons recovering from addictive behaviors or mental health problems, wherein daily activity logs are automatically analyzed for relapse risk assessment.

Several other recent applications are included here to show the growing diversity of integrating advanced technology with MH or PH practices, and to show the uniqueness of the embodiments of this current invention, as described in sections below. Augustinos (US Patent Application 2010 0235517) proposes a communications/networking hub that connects experts in a variety of provider disciplines by parsing requests for assistance according to pre-set rules of dissemination to respective end-terminals. Gazula (US Patent Application 2011 0288888) includes audio and video data capture of face-to-face, real-time interactions between two or more remote users (patients and/or caregivers), into a database, for further comprising an electronic monitoring record which can be indexed and retrieved at a later time. Finally, Grant (US Patent Application 2007 0094039) proposes using a computer network for collecting, evaluating and sharing asynchronous child welfare data for facilitating sharing of said data among a variety of professional personnel involved in health care of the child.

Therefore, a review of the patents and patent applications in the area of advanced technology applications applied to MH or PH sectors do not provide the essential elements of the method described in the embodiments of the following sections.

In order to put the embodiments of this method in proper perspective, it is also important to describe the recent advances and uses of internet technologies for two new areas of mental health practices. First, a brief background on the use of e-therapy will be provided. Second, a background on the creation of social networks, list servs, and other groupings of users connected via technology platforms will be discussed. Wikipedia defines “A social network service consists of a representation of each user (often a profile), his/her social links, and a variety of additional services. Most social network services are web-based and provide means for users to interact over the Internet, such as e-mail and instant messaging.” A key feature of the social network service is the interactive peer-to-peer medium offered for the potential plethora of users.

The last ten years has seen an expansion of internet-supported mental health interventions, often called e-therapy. According to Barak (Journal of Technology in Human Services, 29:155-196, 2011), there has been a number of attempts to deliver technology-assisted interventions that include static web pages to deliver mental health information, interactive cognitive-behavioral based self-help programs, email therapeutic relationships between a client and a MH provider, face-to-face video conferencing between a client and a therapist, tele-therapy, video chat, gaming, virtual worlds, and other creative interventions intended to improve some aspect(s) of mental health. There are now numerous individual and corporate websites that offer opportunities for potential MH clients to select a MH provider from a list of licensed MH professionals. There are websites that offer questionnaires about mental health and pass the information along to providers. However, the existing state-of-the-art, until this method, remains as a legacy approach to MH where a patient either chooses to seek out mental health counseling or may be referred to a MH provider by a private health practitioner who assesses a need. None of the existing websites have methods or means to actively seek out and create the provider-member sub-population communities of this method from the public-at-large for the purpose of reducing health care treatment gaps.

One category that has been missing in prior art technology-assisted interventions is the use of technology to include “reach” of mental health or public health professionals into the lives of those who need assistance. According to Kohn, et al., (Bulletin of the World Health Organization | November 2004, 82 (11)), the care of people with mental health issues is a growing concern. In particular, there is recent research that indicates a global concern on mental health “treatment gaps”, defined as a percentage of the overall population in given countries who likely suffer from some form of mental health problem but do not receive treatment. As cited, it is estimated that the treatment gap for serious depression in the United States was nominally 50% according to the 2004 data. Therefore, it is desirable to develop innovations that can reduce the MH treatment gap across various mental health illnesses. While the root causes for the treatment gap are still the subject of ongoing research, some of those causes are known at this time. For example, there are financial and cost barriers; there are various sources of ‘stigma’ for potential patients, that includes discomfort with disclosure, fear of intrusiveness of therapist questioning, or loss of confidentiality; there are geographical barriers for more rural communities; and there may be cultural barriers, such as a simple lack of trained therapists or PH personnel with adequate linguistic skills for a particular sub-population.

In the United States alone, it was already noted that there are between 11 million and 75 million people in need of mental health care. This is a staggering statistic when the state-of-the-art illustrates that the legacy MH care logistics still rely on a passive approach, whereby people in need of MH services must seek out help before they can be given assistance. Similarly, it is equally sobering to appreciate that the legacy MH care logistics model is essentially a one-to-one ratio. Clearly, there is a need to use technology innovations in a way that a single MH provider, and subsequently, PH providers can rely on innovative methods to reach a significantly higher number of people in need, while simultaneously working to actively minimize the treatment barriers that keep patients from seeking help on their own. The invention described below offers technology-based methods that will allow MH and PH providers to expand reach into underserved populations and simultaneously break down existing treatment barriers to MH care.

It is also an innovative step for this method that the financial cost barrier to treatment is solved with philanthropic donations from other sub-community members for any members who are in need of health-care funding assistance. The shared goal of community health will be the impetus that makes this successful. There is a trend to use email or SMS means to reduce client costs. This approach may be successful in reducing client MH expenditures but there is still need for years of research to understand the efficacy of these new means of MH treatment. In addition, these types of treatments are not reimbursable by health insurance companies at this time and therefore likely represent a small impact on the reach to new clients who must use disposable income to pay the provider, regardless of the amount. Any method that requires out-of-pocket expenses from the client will be at high risk to significantly reduce the treatment gap. This issue will also be seen as a possible limitation on improving MH reach through active screening methods. Active screening is defined as bringing a MH provider into some aspect of an individual's life to have an expert assessment on the need or benefit of MH care for some period of time. Therefore, it is an essential element of this invention that providers can be reimbursed for their services, including an active screening, and that clients not have to absorb their MH care using out-of-pocket financing or unreimbursed wealth. If both these conditions are not met, then widespread adoption of innovative MH methods will very likely not be successful.

The last background discussion that is relevant to this invention is in the area of social networking applications for health services. According to Wikipedia, a social networking service is an online service, platform, or site that focuses on facilitating the building of social networks or social relations among people who, for example, share interests, activities, backgrounds, or real-life connections. Online community services are sometimes considered as a social network service, though in a broader sense, social network service usually means an individual-centered service whereas online community services are group-centered. The sub-population communities of this method are centric in the shared and one-on-one provider-member relationships, which does not exist in any of the prior art.

One very recent development includes the creation of a new social network site called www.nextdoor.com. The website is a closed social networking website that allows neighbors to interact with text messages to one another or recommendations about neighborhood issues. In the area of health social networking sites, PatientsLikeMe is a data-driven social networking health site that enables its members to share condition, treatment, and symptom information in order to monitor their health over time and learn from real-world outcomes. Members are able to find and connect with patients like them, gain social support, and learn first-hand about ways to cope and manage. As mentioned above, Collier (US Patent Application 2011 0125844) proposes a mobile-enabled social network application to support closed, moderated group interactions between registered users of the network for the purpose of enhancing the social resources of users already under medical care and for facilitating therapeutic care. It is proposed that data from the users be retained in a storage medium and analyzed for further medical needs, which might include any variety of health services including mental health. The ‘moderator’ of the group interactions is listed as possibly ‘health care’ providers or others. It is a critical distinction of the method proposed here to notice that the proposed application by Collier refers to “ . . . users under medical care” as the members of the proposed social network. This does not meet the challenge of improving MH active reach with active screening of a sub-population nor does it meet the existing payment and payment reimbursement models that exist today in the health care environment. It is also notable that existing health social networking sites are focused on particular health areas and do not generally attract members of the population-at-large, nor do they offer continuous access to a health care provider. Therefore, this invention is dedicated to a new type of online community where its membership is comprised of sub-populations from the community-at-large, as selected by public health expertise, and the mission of the technology-based community is to facilitate active screening of the population at large for potential health care needs, in particular mental health care, so as to reduce the health care treatment gaps known to exist today.

The history of social networking, thus far, even in consideration of Collier's patent application is that the network runs on a “24/7” schedule and the realistic challenge is to identify a ‘health expert’ moderator that can span such a schedule while being reimbursed for their time. The costs for health provider staffing of such a health-oriented social network is likely to run into challenges. This is one reason that others have proposed automated analyses of communication archives or databases (e.g. Shaw, Collier, Gazula in discussions above) in order to make assessments of certain health conditions using certain metrics according to their inventions or proposed inventions. However, it is also a very real barrier to treatment, at this time, that there are no provisions for health insurance reimbursements to health care providers who would serve as moderators or staff members for health-oriented social networks. There are three important reasons for this barrier. First, a social network is by definition a peer-to-peer engagement and the interaction of a MH moderator does not meet the criteria required for health insurance reimbursement without the definition of an assigned ‘group therapy’ session. Second, the network construct of a social network does not readily lend itself to legacy face-to-face MH provider interactions, and hence, the insurance reimbursement policies may take years to resolve. (The financial barrier for individuals with no health insurance is a further concern.) Third, the lack of one-to-one engagement with the legacy operational style of a social network is outside the traditional training of assessment and diagnosis for MH providers, and it may take years for professional organizations to resolve the efficacy of any proposed delivery methods for this type of network. It is a further obstacle to treatment that the nature of social network memberships is a legacy recruitment model whereby clients may or may not join a health-oriented social network, and hence does not solve the problem of reducing the treatment gap. Additionally, the efficacy of automated database assessments of health-oriented social network members' health-related needs, especially mental health needs, is going to take many years to be validated by the scientific mental health community. Finally, the overwhelming abundance of 24/7 communications data from a health-oriented social network can include audio, video, user profile information, posted pictures, text messages and more. The time required for a MH provider to assess this data for MH diagnoses is going to be quite lengthy, if not impossible, before expert rules are approved by the MH community. The time spent looking over analysis data provided by computational means has no precedence as a “billable hour” with insurance companies. All of these considerations will likely significantly reduce the number of MH providers willing to work with any social networks as they exist today, until a number of important changes are made. This method seeks to offer such changes.

One final challenge to the use of health-oriented social networks, or other forms of online groups is the potential for either anonymity (“disappearing into the crowd”) or domination (“the one who's always talking”) to reduce the opportunity for equal focus of a MH provider on all individuals within a sub-population of interest. This challenge will be exacerbated with large social networks or online groups. It will be more beneficial towards reducing the treatment gaps of MH illnesses if MH providers are integrated within an electronics communication-based method that ensures equal personal interaction with, or provider observation of, every sub-population member over some chosen interval of time. In addition, it is also important that the amount of time expected for interaction between sub-population members and MH providers and PH providers is kept reasonable to provide best chances of success for the method to achieve its objective of reducing the treatment gaps in MH illnesses. No prior art in the area of computer-based MH assistance addresses this specific issue.

There is also relevant background in the relationship of mental health of individuals to the public health of the communities in which said individuals can reasonably be considered as members. A growing trend, based on concerns for improving the overall public health of communities worldwide, is the focus on agreeable ways to identify community health metrics. One example is the use of social determinants. While public and community health metrics span a wide array of social determinants, there is a critical subset of social determinants that are intrinsically coupled to the mental health of individuals in the community. Examples of those determinants include discrimination, social isolation, social status, trauma, mental health literacy, and availability of health insurance. Public health agencies emphasize the link between mental health and public health as one key dimension of overall health. The Substance Abuse and Mental Health Services Administration (SAMHSA) stated in a 2012 conference that they envision “a future in which people with mental and substance use disorders pursue optimal health, happiness, recovery, and a full and satisfying life in the community.” Clearly, the relationship between MH and PH cannot be ignored. It is also true that PH and physical health have large impact on community health. No prior art has attempted to use advanced technology or computing to simultaneously seek out community members of sub-populations using PH experts, provide access to MH or other health care providers, using methods that will clearly lead to financial reimbursement of the provider services and minimize cost of the advanced technology components used to engage the providers with the community members.

Finally, there is also need for innovations that can accelerate the role of MH and PH experts in breaking down stigma barriers for MH care at the sub-population level. The well-understood role of building trust in human relationships will be leveraged in the method described herein. By integrating specific MH providers with sub-population members in both one-on-one and collective ways, growing familiarity between the member and the MH providers will ideally overcome any member distrust of the MH treatment processes. Community peer support will also grow in acceptance of MH care as a healthy choice instead of being perceived as representative of some deficiency in the life of any individual. It is also an important background aspect to this invention that the MH and PH provider is not given “carte blanche” authority over the sub-population. The presence of 24/7 monitoring may have a place in certain situations but it also offers some risk to the level of willing participation of all individuals in sub-populations. This method seeks to maintain the prevalence of ‘choice’ and ‘privilege’ for the individual to manage his or her own life, even while improving the acceptance of MH care as an integrated part of living a better life.

Therefore, what is needed is: a new network-interfacing method that will increase reach of health care providers, especially MH providers, right now into virtually any sub-population or community demographics based on the oversight of PH experts to seek out and recruit sub-population community members from the public-at-large; and a method that has potential to reduce the approximately 50% treatment gaps for a number of MH illnesses; and will eliminate certain health care treatment barriers to include geographical and stigma barriers; and will operate on approved practices for face-to-face screening by providers, and will allow reimbursement of the time that any health care providers' spend on the sub-population interaction within the current constraints of provider health insurance reimbursement policies, and will provide automated means for philanthropic or social agency donations to cover any potential provider costs of said sub-population community members that do not have health insurance, and will not lead to exorbitant new technology costs for the potential clients or service organization of said method. Furthermore, the network-interfaced health care provider method will simultaneously provide a new means whereby PH and health care providers can actively seek out and engage potential clients instead of the legacy model whereby potential clients seek out, or not, health care providers; and will simultaneously provide a new means to foster PH well-being and social inclusion among individuals of sub-populations that share either geographical, cultural, linguistic, or other common attributes that comprise the definition of a community. Furthermore, the method offers a solution to the problem of technology skills barriers of certain members.

### BRIEF SUMMARY OF THE INVENTION

The focus of the present invention is a new method for a computer network-interfaced provider and sub-population community for the purpose of overcoming a number of current obstacles that need to be eliminated in order to reduce the treatment gap in health care services to the entire population-at-large. The method includes network-interfaced computing means of at least one health care provider, that is interfaced to a computing means of at least one member of a sub-population community for the purposes of periodic one-to-one interaction for health care assessment or treatment or referrals to other health care providers and to foster a sense of public health in the said community. The network-interface method includes a secure remote access component whereby the provider can routinely implement control of a member's computing means for the purpose of overcoming any technology-skills barrier that would prevent successful “online” interactions and for a means of minimized security risks of any data that is transferred from a member to a provider network-interfaced computing memory storage means. For example, the provider administrator can take control of the member's computing means via secure remote access to ensure that adequate video conferencing applications are installed and operational on the member's computing means, in the event that the member is not technically skilled to complete such a task. The method step of secure remote access can be customized applications or can use existing applications built for the operating systems of various computing means of various members. Some of those secure remote access applications include, but are not limited to, Windows Server 2008 NPS Routing and Remote Access VPN services, Windows Server 2008 Terminal Services Gateway, Microsoft ISA 2006 and Forefront Threat Management Gateway (TMG), Intelligent Application Gateway 2007 and Unified Access Gateway (UAG), or Network Connect for Mac. Virtual desktop architectures can also be used as the secure remote access method step.

The network-interface method also includes a public health-care expert administered website software to facilitate a registration process for the sub-population community, said registration process to include essential elements of: assignment of a registering member to a specific sub-population community based on either geographical, cultural, linguistic, or health-care interests of the member or shared corporate employment or shared employment at a government agency or other collective groups of such nature; and collection of insurance information from each member; and obtaining e-signatures of all required privacy and security notifications associated with remote health care access and to obtain permissions and necessary computing means identifications (IP address, etc.) for provider secure remote access of a member's computing means. The network-interface method offers continuous access between providers and members according to specified operating hours and according to appointment times assigned to specific members during which an at least one computing means of an at least one health care provider will share a secure remote access connection to the specific member's computing means during said appointment time. The method further includes an active health care screening step by an at least one health care provider using the production of a life-episode audio-video recording of a small time slice in a member's life based on certain provider-developed protocols that guide the life-episode production. The protocols will facilitate active screening means and will be designed to readily illuminate certain areas of lifestyle that might indicate a benefit of a health care intervention.

One embodiment of the method provides a means for mental health providers to facilitate active screenings and subsequent MH provider referrals for a multi-member sub-population of interest, while simultaneously supporting public health assessments of said sub-populations (communities) of interest, and providing a new means for improving social inclusion of all individuals in said sub-population through the production of a life-episode of each member on a provider-determined schedule. The embodiment is comprised of a network of computers, to include the at least one computing platform for each member of the sub-population community, the at least one computing platform for the MH and PH providers, the at least one computing platform for web-based software that is used to conduct registration of the sub-population community members and provide other related services to the members, and the at-least one computing and computing memory storage means to archive, and make accessible, life-episode broadcasts as described in the embodiments and claims of this invention. This network of computers will hereafter be referred by its component elements, if it facilitates the description of the method, or referred to as the network if it is used in the context of the entire sub-population community embodiments.

The network is arranged to facilitate the production of, and broadcast of, a brief audio-video recording of some selected aspect of a community member's life situation, hereafter referred to as a life-episode. One life-episode will be broadcast using a periodic schedule, that can be adjusted to user preferences, from one individual in the sub-population to all other individuals in the sub-population using a life-episode format agreed upon using a protocol developed in participation with the health care providers. Without loss of generality, the embodiment will be described in the context of a MH and PH provider. Each individual's life-episode production is co-directed by the individual and the MH or PH expert, and includes personal audio and video components and is securely streamed to other members of the sub-population of interest at a pre-determined time, to solicit interaction with other community members in real-time, for example with tweets or SMS responses. The life-episode will also be archived using a storage medium component of the network for asynchronous viewing by the sub-population members at a later date, as a means for improving social inclusion and overall community well-being through familiarity of each member with all other members. A web-based software that is accessible via an internet connection will be used to access the archived life-episodes at a later date by logging on with a user name and password assigned by the web site administrator. The archived episodes may serve as a means to facilitate the assessment of any potential needs for a single member's MH care or to serve as data for PH assessments of the sub-population community, when the archival episodes are considered collectively. The archived episodes may also serve to build a sense of community within the sub-population of interest.

The life-episode production will be created while the MH or PH expert provider is present with the individual member either personally or through secure remote access to the individual's computing platform with which the video and audio components of the broadcast will be processed and streamed. In another embodiment, the expert provider may be of a different health care background, to include psychiatry, social worker, physician, physician assistant, and other health care providers, without loss of applicability to the benefits and novelty of the present invention.

Membership recruitment for particular sub-population communities can occur by word-of-mouth, web advertisements, public health notices, door-to-door, telephone contact, email contact, and other forms of advertising. The MH and PH experts will initiate a new sub-population community if warranted by the cultural or geographical consideration of a new member, or assign a member to an existing sub-population community. Registration of members in the sub-population community occurs via the website design and will include secure means for providing personal information, including health insurance information in a level of detail that will allow billing for active screenings or a MH assessment with a member. Members will be given informed consent documentation in regards to the desired advocacy relationship between a member and the MH and PH providers, and be given privacy concern literature to ensure all applicable privacy regulations (e.g. HIPAA) are being met in the jurisdiction(s) of the community. A member can be defined as an individual in some situations or may be a family in another situation. For example, if a household has a family health insurance policy, it will be possible to register a “family” member. If a household has two individuals with two different health insurance policies, it will be permissible to register two members from a single household in the same sub-population community. Once a member is assigned to a sub-population community, that member will be given access to real-time broadcasts of other member's life-episodes according to a broadcast schedule, and will be given access to any life-episode archives, either of which will only be for the sub-population community for which the member is registered. It is well known that other social networking sites exist, in their many categories and it will be seen that the technology-based sub-population communities described in this invention are not similar in design to any of those social networking designs. This MH and PH provider integration with the closed-network arrangement of the current invention is to facilitate social inclusion within the prescribed community for the respective members for the purpose of improving overall community aspects of public health using expert PH oversight, as well as to improve reach of MH providers into the public-at-large, and to make the case-work manageable for the MH provider by virtue of the reasonable size of the sub-population communities and the scheduled interactions of this method.

The method's web site software support will include a secure means for advertising a need for philanthropic donations or social agency funding that may be desired for any sub-population community members who do not have any form of health insurance coverage. The member in need will be kept anonymous for obvious reasons and the potential financial donors may contribute to a MH care fund anonymously or not. The website will provide accounting summaries for any donations received and the expenditures for those funds will be limited to provider reimbursement for the members in need according to legal documentation associated with the donations or social funding. The benefit of this aspect of the method is that the active reach into a community can identify if there is a financial barrier to treatment caused by lack of health insurance and if so, remedy the situation. This active reach to overcome a well-known financial barrier of MH care in a community is seldom practiced at this time, if at all.

In another embodiment of the method, there is a temporarily networked group of personal computing devices, at least one for each member, and at least one for each MH and PH provider, with the MH and PH provider having secure remote access to the member computing means that is selected to produce and broadcast any scheduled life-episode, said remote access being arranged for the purposes of co-directing the life-episode using one of any number of protocols developed by the MH and PH providers. The computing means can be any device that processes and/or plays back signals from a video camera and microphone live broadcast, which includes at least a desktop computer, a laptop computer, a tablet PC, a mobile ‘smart phone’, a netbook computer, a thin client, a dumb client, or other devices. In this embodiment, the MH or PH provider can archive the life-episode broadcast on the member computer memory, or the provider computer memory, for playback to other sub-population community members at a later date.

In another embodiment of the method, there is a temporarily networked group of personal computing devices, at least one for each member, and at least one for each MH and PH provider, and one central server that is connected to all of the computing devices for each member computing device and each provider computing device, with the MH and PH provider having remote access to the computing means that is selected to give the broadcast, for the purposes of co-directing. It is further understood that the computing means can be any device(s) that processes and/or plays back signals from a video camera and microphone live broadcast, which includes at least a desktop computer, a laptop computer, a tablet PC, a mobile ‘smart phone’, a netbook computer, a thin client, a dumb client, or other devices. The central server can be a computer running a server operating system or a cloud platform configured as a private cloud, or a public cloud, or a hybrid cloud. In this embodiment, the MH or PH provider can archive the life-episode broadcast on the central server computing device for playback to other sub-population community members at a later date via links on the network website.

In another embodiment of the method, there is a temporarily networked group of personal computing devices, at least one for each member, and at least one for each health care provider, with the health care provider having secure remote access to the member computing means that is selected for an interaction according to an appointment schedule. The computing means can be any device that processes and/or plays back signals from a video camera and microphone live broadcast, which includes at least a desktop computer, a laptop computer, a tablet PC, a mobile ‘smart phone’, a netbook computer, a thin client, a dumb client, or other devices. In this embodiment, the health care provider can interact with the member for the purpose of providing assessment, diagnosis, referral, treatment plan, or prescription information using encryption techniques that are consistent with Federal Information Processing Standards (e.g. FIPS 140-2).

In another embodiment of the method, there is a temporarily networked group of personal computing devices, at least one for each member, and at least one for each health care provider, and one central server that is connected to all of the computing devices for each member computer and each provider computer, with the health care provider having secure remote access to the computing means that is selected for an interaction according to an appointment schedule. It is further understood that the computing means can be any device(s) that processes and/or plays back signals from a video camera and microphone live broadcast, which includes at least a desktop computer, a laptop computer, a tablet PC, a mobile ‘smart phone’, a netbook computer, a thin client, a dumb client, or other devices. The central server can be a computer running a server operating system or a cloud platform configured as a private cloud, or a public cloud, or a hybrid cloud. In this embodiment, the health care provider can interact with the member for the purpose of providing assessment, diagnosis, referral, treatment plan, or prescription information using encryption techniques that are consistent with Federal Information Processing Standards (e.g. FIPS 140-2).

Sub-population communities will be created based on the oversight of a mental health expert and/or public health expert, using a choice of ‘boundaries’ that can include geographical or cultural or other as defined by the expert coordinating the creation of the sub-population community. For example, in one embodiment, the sub-population community is a neighborhood. In another embodiment, the sub-population community may be an entire rural community. In another embodiment, the sub-population community may include a number of Spanish-speaking households that are spread across some geographic distance. One primary objective of the sub-population community is to give the members access to a mental health expert for the purpose of active screening to reduce the MH treatment gaps cited in the research literature. Another objective of the sub-population community is to foster a sense of well-being through the relationship of the community with a mental health expert and advocate, as well as a public health expert. Therefore, there are advantages for embodiments that are based on geographical sub-population communities in some cases, for example in the case of “hot-spot” communities where there is a high need for health care. There are also advantages for applying cultural boundaries to create the sub-population community, for example when Spanish speaking households are geographically isolated from other Spanish speaking households and their inclusion can add to their social well-being through the sense of community offered by the sub-population community network. It is clearly seen that there are other geographic and cultural dimensions that can form the basis for the experts to place the different household members in the optimal sub-population for their well-being.

The network-interface method includes a computing means to operate integrated software to stream a live broadcast of a member life-episode at a pre-determined time for the sub-population network and simultaneously record the life-episode on a central server for asynchronous viewing at a later time. Each member broadcast computing means is connected to a remote computing means for the MH provider and the PH provider, and is networked to computing means under the control of all other members in the sub-population network. The computing means of each individual member and the MH provider and the PH provider can be one of many obvious designs, including a desktop computer, a laptop computer, a tablet PC, a mobile ‘smart phone’, a thin client, a dumb client, or any other computing means that records and plays back audio/video data streams. The integrated software may be customized audio-video software or may be commercially available software, such as video-conferencing software that supports multiple users, depending on which software is more cost-beneficial at any stage of the invention. The use of commercial video-conferencing software is seen not to diminish the inventive steps of the MH and PH provider connectivity to the sub-population communities described herein to produce and broadcast and archive member's life-episodes for the purpose of improving mental health care reach into the public-at-large and improving community public health through the social inclusion benefits that will be realized via sub-population community sharing of life-episodes of the respective members. In fact, the use of commercial video conferencing software may be seen as a creative way to manage costs of the invention.

The life-episode protocols will be designed by MH and PH experts, or by other health care experts without loss of application to the key elements of the method. The life-episodes created by the members are intended to present the respective members in a positive manner to other members of the sub-population community who may know very little about the member who is sponsoring the life-episode of a scheduled broadcast. The MH provider and PH provider will offer a series of protocols for the life-episode that seem best-suited for that member to present in a most positive light to other members. Examples of the protocols may be as straightforward as the preparation of a meal for the member household, or an introduction to all family members with some disclosing information about their likes or hobbies, or a presentation of some important accomplishment by the member or member family, or if deemed warranted, some historical background on the member (culturally, geographically, educationally, etc.), or a wide variety of other protocols in a similar vein. If deemed warranted, a member may wish to discuss a positive experience they may have had with mental health care or some other aspect of public health. There will be an extensive number of protocols that all stay within the inventive description of having sub-population community members produce and broadcast and archive a life-episode, with the guidance and co-direction of a MH and PH provider expert. One inventive step of the provider-assisted life-episode protocol is intended to meet the need to break down the stigma barrier of mental health care and to promote community health in ways that PH experts are trained to understand.

The embodiments of the provider and sub-population community network described above will be designed using cyber-secure techniques and HIPAA approved practices for data handling.

It is seen, therefore, that this method offers a new opportunity for health care providers to engage any or all members of the public-at-large, versus prior art which engages existing patients, while maintaining an element of structured information flow between members of an intentionally designed sub-population community, so as to give the provider an opportunity to assess MH and other health care needs in each and every member of the sub-population community over some fixed interval of time, make referrals or provide treatment when necessary, and have said actions, be compatible with insurance reimbursement policies that currently exist.

It should be further appreciated that this method offers an opportunity for rural communities to gain access to a dedicated MH and PH provider, with the advantage of steadily increasing provider knowledge of the community culture, by means of the internet connectivity of the network components previously described, so as to reduce both geographical and possible cultural barriers to treatment. The legacy model of having rural community members seek health care ‘on their own’ does not offer this benefit of the method described here, nor do the legacy models of social networks in existence today offer this benefit.

### DESCRIPTION OF THE DRAWINGS

FIG. 1 illustrates the concept framework for the method's administrative parsing of members into appropriate sub-population communities using web registration process.

FIG. 2 illustrates a first embodiment of the method's network-interface with health care provider computing means secure remote access to sub-population community member computing means and health care information archiving via secure remote access link to provider computing means memory.

FIG. 3 illustrates a second embodiment of the method's network-interface with a central server and health care provider computing means secure remote access to sub-population community member computing means and health care information archiving via secure remote access link to transport health care information to the central server memory and to member computing means.

FIG. 4 illustrates a third embodiment of the method's network-interface with MH and PH provider secure remote access to sub-population community member production computing means and information/life-episode archiving via secure remote access link to provider computing means memory.

FIG. 5 illustrates a fourth embodiment of the method's network-interface with a central server and MH and PH provider secure remote access to member production computing means and secure remote access link to transport health care information data and life-episode archives to server memory or cloud platform memory.

FIG. 6 illustrates key features of network-interface web software to implement method steps for: sub-population communities' member registration, protocol lists and download to members, archival logon and life-episode playback, appointment and life-episode production schedules for members, member health insurance billing logs, philanthropic donations for community members; and health-care provider appointment scheduler.

FIG. 7 illustrates the method's arrangement of provider and production member computing means during one-on-one consultations for the purpose of consistency with health insurance provider reimbursement authorization based on telehealth paybacks in many states.

FIG. 8 illustrates a list of potential life-episode protocol descriptions for production of life-episode audio-video method step.

FIG. 9 illustrates the method's network interface and representation of life-episode archival playback process for a sub-population community member.

FIG. 10 illustrates the method's representation of life-episode analysis step by a health care provider of the sub-population community for the purpose of offering consultations to members on health care issues.

### DETAILED DESCRIPTION

The following terms are used in the description that follows. The definitions are provided for clarity of understanding:

### MH: Mental Health

### PH: Public Health

### FIPS: Federal Information Processing Standards

O/S: Operating System of a computing means

### GUI: Graphic User Interface

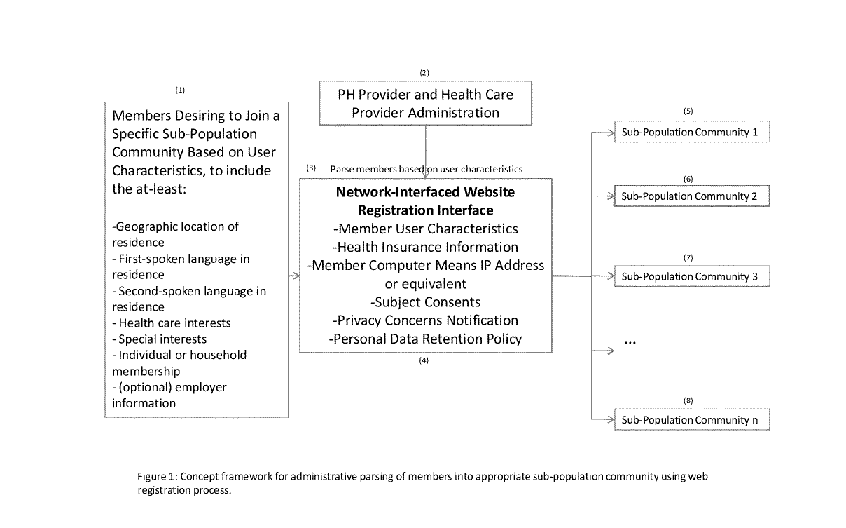

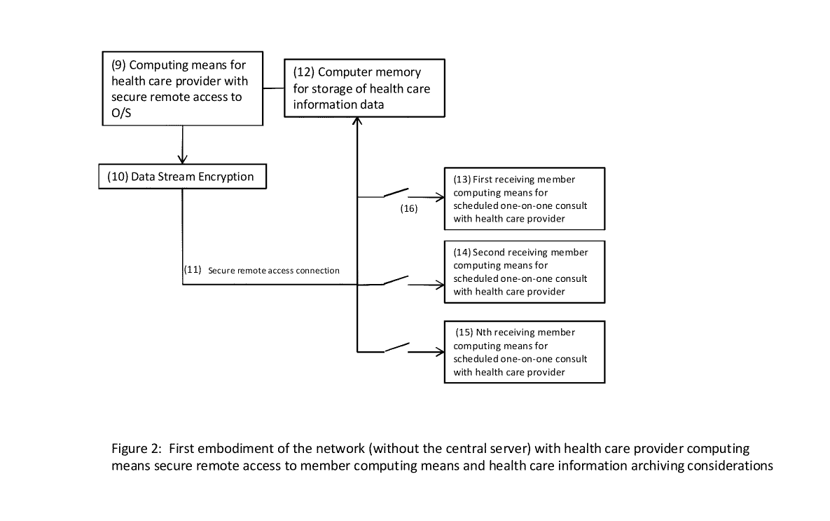

FIG. 1 illustrates the method's registration process for the purpose of an at least one health care provider assessing the at least: (1) user characteristics, and a remaining registration step (4) including health insurance information, member computing means internet protocol address information, e-signature of member subject consent for health care provider consultations, e-signature of member privacy concerns notifications, and e-signature of member data retention policies. The registration process is one of the first steps of engagement in the method of this invention and the health care administrator (2) will use said information for the step (3) of parsing the registering user into a specific, and singular, sub-population community (5) based on criteria determined from the user characteristics (1). In one example of the parsing step of the method, a PH administrator will determine that the user is located geographically in a particular region and will decide how to parse the user into any sub-population community that is comprised of other members within close proximity of the registering user's geospatial address. In another example of the parsing, the PH administrator will determine that the user characteristics indicate beneficial membership in a sub-population community that is comprised of Hispanic-speaking members, regardless of geospatial address. It is understood that the parsing step can be manual or automatic, but each parsing action will be based on administrator rules for the parsing process. It is further understood that there may be one sub-population community (5), or a second sub-population community (6), or a third sub-population community (7), or as many as ‘n’ sub-population communities (8), where ‘n’ can be any arbitrary positive whole number. The internet protocol (IP) address information will be provided by the registering user or will be sought from the website software providing a temporary interface to the user's computing means, for the purpose of identifying the IP address. A ‘ping’ is a common approach for this type of interface or software that can ‘fix’ the IP address of a sub-population community member. The registered IP address will be used for future means of secure remote access from a health care provider computing means to a member computing means, depending on the operating system of the respective computing means as discussed in conjunction with the detailed embodiments described under FIG. 2 through 5 below. It is further understood that virtual desktop applications can be used as an embodiment of the secure remote access feature of the method.

It is further understood from FIG. 1 that the purpose of the health insurance information registration step is not associated with sub-population community parsing and no discrimination of membership is based on health insurance availability or not. The health insurance information provided by each user, and subsequent sub-population community member, is for the step of having health care providers, using secure remote access as discussed in FIGS. 2 through 5, be able to receive authorized health insurance reimbursements for interactions with the members. The subject consent approvals by registering members are to provide legal agreements between members and providers for all interactions as defined by this method. The privacy and retention of data consents are to ensure that member rights are met and all parties understand and agree how all data will be used or archived.

FIG. 2 illustrates a first embodiment of the method in which the at-least one health care provider computing means (9) is linked, using secure remote access (11) software, to the at-least one sub-population community member computing means (13, 14, 15). The secure remote access (11) will be compatible depending on the operating system (O/S) of the two computing means linked at any given time in the method. There are commercial versions of secure remote access software that can be utilized for this step of the process or a custom secure remote access may be designed. The commercial versions include, but are not limited to: Windows Server 2008 NPS Routing and Remote Access VPN services, Windows Server 2008 Terminal Services Gateway, Microsoft ISA 2006 and Forefront Threat Management Gateway (TMG), Intelligent Application Gateway 2007 and Unified Access Gateway (UAG), or Network Connect for Mac. Virtual desktop applications may also be used for secure remote access. The data stream (10) between the health care provider computing means (9) and the member computing means (13, 14, 15) will be encrypted using FIPS 140-2 quality encryption and said data stream can include any substantive communications, information, audio/video, or other data means that facilitates a provider's screening or treatment of a sub-population community member.

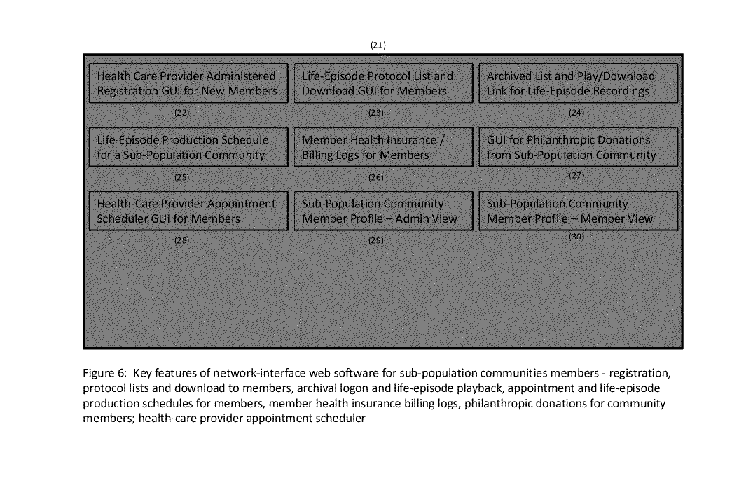

Furthermore, FIG. 2 illustrates the network-interface topology for an embodiment where the secure remote access (11) link across the network from provider to member takes place on a scheduled basis or appointment that is made via a website selection process as defined in (28) of FIG. 6. When health care information is transmitted via a data stream (10) to a member computing means (13, 14, 15), it will also be transmitted to a computing storage memory (12) on the provider computing means.

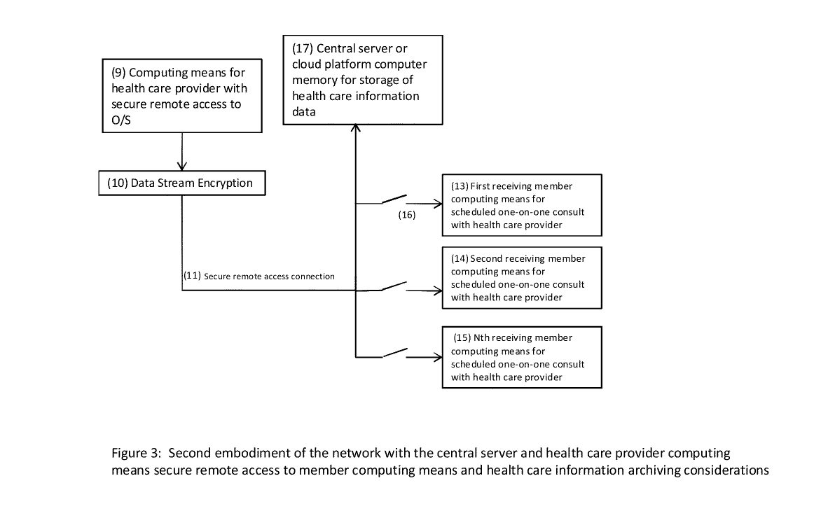

As illustrated in FIG. 3, a second embodiment of the method includes all of the steps in the embodiment of FIG. 2 but also includes a different means for storage of the encrypted data stream (10) comprising health care information from provider to member. In this embodiment, the computing memory is housed on a central server or cloud platform (17) as opposed to the provider computing means memory of the first embodiment. The server or cloud platform storage will serve to make the archived data more manageable by IT experts or more accessible by other persons who may need to share or gain access to the data, provided permissions for data sharing are agreed upon with each member.

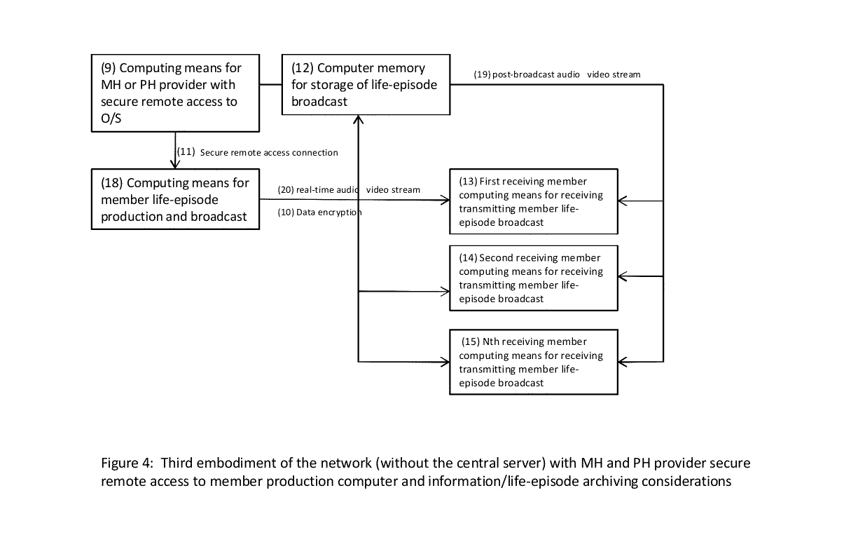

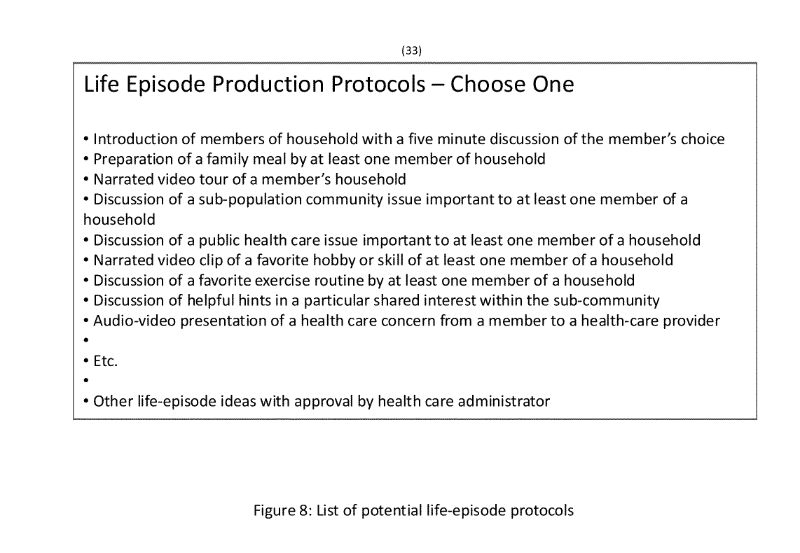

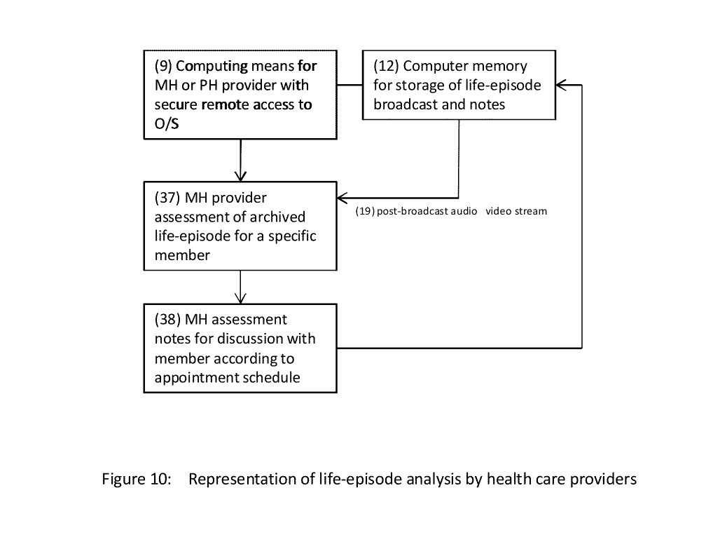

FIG. 4 illustrates a third embodiment of the method to show an example of how the method might be used for the scenario of combined mental health and public health provider interactions with a particular sub-population community. In this embodiment, the provider computing means (9) belongs to a MH provider or PH provider, who utilizes the method's secure remote access connection (11) to the network-interfaced member computing means (18). In this embodiment, the MH or PH provider computing means (9) can communicate with the member's computing means (18) for the purpose of guiding the production of a life-episode data according to a protocol (33) downloaded from the method's web-site graphic user interface (GUI) as described later in FIG. 6 and FIG. 8. Using the secure remote access connection (11), the MH or PH provider may take control of the member computing means, if necessary to overcome a technical skill challenge due to a member's lack of computing skills to produce said life-episode audio-video production. In another example of this embodiment, the member will have sufficient technical skills to produce the life-episode data and the secure remote access connection will be used by the MH or PH provider to assist in the production and to preview the production before release to the rest of the sub-population community members. The purpose of the preview step is to enlist the community health expertise of the MH or PH provider so that the life-episode broadcast will serve to offer a means of enhanced sense of community for each member and to ensure that the life-episode is sufficiently produced so that key steps of the protocol are successfully completed, thereby assisting in mental health or public health screening steps as defined in the method step defined in FIG. 10.

Furthermore in the third embodiment of the method as shown in FIG. 4, a completed life-episode will be broadcast to other sub-population community members who wish to view the life-episode broadcast in real-time, and the life-episode will be simultaneously stored on memory. The life-episode will be an encrypted (10) audio-video data stream (20) connected through the method network-interfaced computing means to other members (13, 14, 15). The data (20) will also be stored on the provider computing means memory (12) for this embodiment. Storage of the life-episode data will allow each member to download a post-broadcast view of the life-episode audio-video stream (19) to their computing means at a more convenient time or to repeat a viewing of the life-episode. This embodiment is seen to be one of many possible scenarios that can be implemented as a valid reproduction of the method offered here.

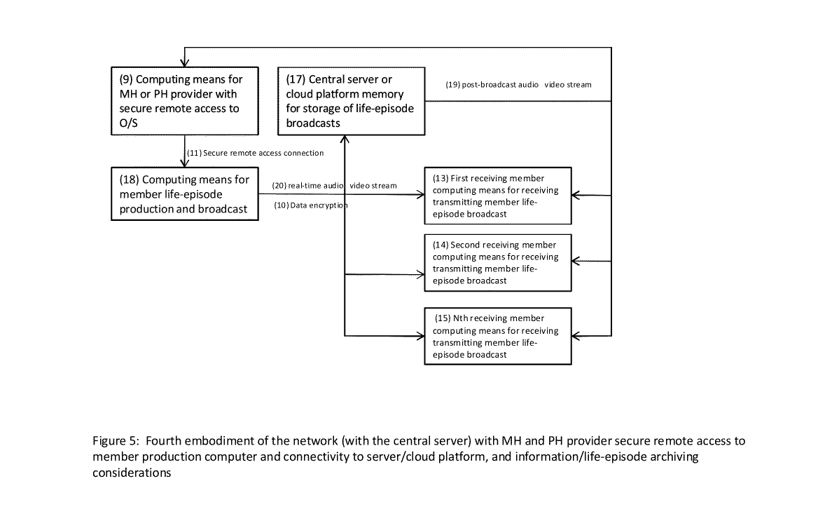

A fourth embodiment of the method is shown in FIG. 5. This embodiment is identical to the embodiment of FIG. 4 except that the storage of the life-episode audio-video data stream includes the step of storing on a central server computing means memory (17), as opposed to the provider computing means memory, without loss of efficacy for the method.

FIG. 6 illustrates key features of the method's network-interface web software for sub-population community members. The registration step (22) of the method was covered in detail in the illustration of FIG. 1. The other key features of the web software for the method will now be provided. A life-episode protocol list and GUI for downloading a particular protocol is shown in (23). FIG. 8 will provide more detailed description of the protocols for the method. Members will utilize their network-interfaced computing means and secure logon information (username and password) to access the method's GUI (23) and select a protocol for a life-episode production when they are scheduled to work with the health care provider on the production. In (24), members will logon to view and play or download archived life-episode productions from sub-population community members. It is obvious that the GUI for this step of the method will direct the members to the appropriate memory storage as defined by either (12) or (17) in the prior descriptions of method embodiments. The step of (25) provides the sub-population community schedule for life-episode productions and will be accessed by members with a logon process to the web software. It is also an obvious alternative to have the web software deliver the schedule to the members via email, or SMS test, or other means using the network-interface of the method.

The method's web software of FIG. 6 will also offer a log of all insurance billings (26) for provider interactions with each respective member of a sub-population community. Secure logon will be required for the member to view history of insurance claims submitted by the provider and claims that are closed for action, following payments. Another GUI of the method website is intended to promote optimal community health of a sub-population community, by providing a means for community members to anonymously provide financial support to a sub-population community member who may be in need of health care but without insurance or other revenue to pay for said health care. This step of the method is considered to be part of the active reach to reduce health care treatment gaps in the event that a financial barrier to treatment is identified. In (27), members can logon to view any financial need for health care in the community and make a payment, and philanthropic donation, using credit, or debit, or paypal, or other financial payment methods available for web-based payments.

In FIG. 6, there is also means to use the web software of the method to allow members to select specific appointment times for consultations with a health care provider associated with their sub-population community. The GUI of (28) offers a network-interfaced step of the method so as to offer a member to sign up for a convenient time for any consultation with a provider, be it for a life-episode production, a discussion of a health care concern, a mental health treatment tele-session, or other consultations in the area of health care.

Two remaining features of the web software required for the method will include two distinct views of a sub-population member's profile. In (29), an administrator view of a member profile will include health insurance information for a member, prior health insurance billings, health care histories, provider notes about the member, and personal information about the member's user characteristics. In (30), the member profile will also have a member view in which the member sees the same information as the view in (29) except for the provider notes.

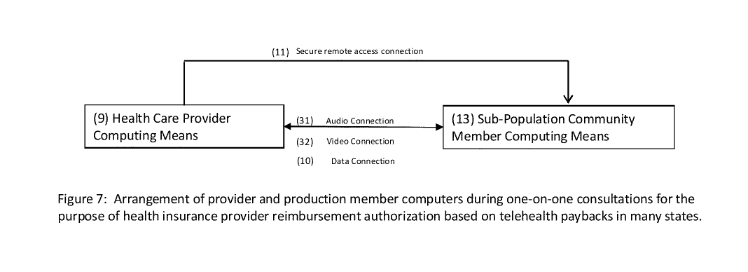

The illustration of FIG. 7 shows the network-interfaced view of the method for a single, scheduled, one-on-one consultation between a health care provider for the sub-population community and a sub-population community member using an audio (31)-video (32) link, and a secure remote access (11) link. It is a notable feature of this inventive method to include the secure remote access link, so as to overcome the expected technical skills barrier to network-interface (internet) health care treatment of a large number of individuals in the population-at-large, and subsequently in the sub-population communities of the method. As stated previously, the secure remote access (11) offers the means for the provider to operate the member's computing means to set up a video conference link, for example, in the event that the member's technical skills do not allow them to successfully complete the set up on their own. It is further noted that this embodiment is not known to the prior art of social networks or online communities, and is an inventive step of this method. It is necessary to be able to overcome the technical skills barrier that adds to the health care treatment gap being solved by this network-interfaced method.

FIG. 8 illustrates a number of possible life-episode protocols that are acceptable for serving the purpose of community health enhancement of the method, whereby mental health screenings are part of the community health enhancement. The protocols are developed to guide the life-episode productions for the purpose of improving active reach into communities for the purposes of reducing the treatment gaps of health care, improved mental health of community members, and improved community health, including social inclusion and well-being of all members. Therefore, it will be apparent that experts can identify other protocols that will fit this step of the method. Each protocol will be designed to facilitate rapid assessment of a particular, or multiple, aspect of mental health as deemed important by those trained in the mental health discipline. The protocols may also be designed to facilitate screenings for other health care disciplines without loss of the method's intent.

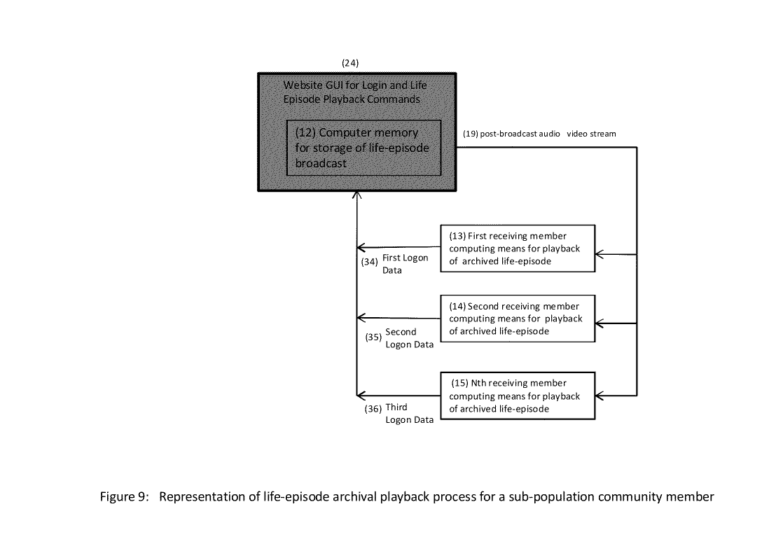

FIG. 9 illustrates the details of the web-based software element of the method, where the life-episode archives are stored on (12) and members may use their computing means (13, 14, and 15) to log on (34, 35, 36) through the web-site GUI (24) and watch a playback of the life episode (19).

FIG. 10 illustrates another step of the method where the life-episode is used to assess certain mental health expert expectations or observations of potential benefits of possible provider treatments. Viewing the life-episode archived audio-video stream (19) from the memory means (12), the health care provider can observe the life-episode on a computing means (37) audio and/or video playback device and generate assessment notes (38) for insurance requirements and member review at a subsequent scheduled time with the member who produced the life-episode, said time based on the member using the appointment GUI (28).

The previously described embodiments of the present method offer a means for active reach of health care providers into sub-population communities selected based on user characteristics and public health interests for said communities. It will be appreciated those skilled in the art that the health care providers may be of a variety of disciplines, and the sub-population communities will be varied, without departing from the scope of the present method.

A computer network-interface method for active reach of health care providers into sub-population communities selected based on user characteristics and public health interests for said communities has been described. It will be understood by those skilled in the art that the present method may be embodied in other specific forms without departing from the scope of the invention disclosed and that the examples and embodiments described herein are in all respects illustrative and not restrictive. Those skilled in the art of the present invention will recognize that other embodiments using the concepts described herein are also possible. Further, any reference to claim elements in the singular, for example, using the articles “a,” “an,” or “the” is not to be construed as limiting the element to the singular. Moreover, a reference to a specific time, time interval, and instantiation of scripts or code segments is in all respects illustrative and not limiting.

What is claimed is:

1. A method for actively providing health care access to an entire sub-population community, comprising: a computing network to continuously connect the at least one network-interfaced computing means of health care providers to an at least one network-interfaced computing means of sub-population community members according to specified hours of operation; and to produce an at least one data stream to be broadcast from the at least one network-interfaced computing means of a health care provider to the at least one network-interfaced computing means of at least one of a sub-population community member using secure remote access connection to the sub-population community member computing means according to a scheduled time; an at least one network-interfaced computing means of a sub-population community member to produce an at least one data stream to the at least one network-interfaced computing means of a health care provider using said secure remote access established by the at least one provider computing means; an at least one public health care provider administrated computing network-interfaced website software registration step to assign a new member to an at least one sub-population community; a transmission of provider health care information via the secure remote access between the network-interfaced computing means of the at least one provider to the to network-interfaced computing means of an at least one sub-population community member; and a provider network-interfaced computing means memory to store records of communicated provider health care information and health care information communicated by the at least one sub-population community member.

2. The method according to claim 1, where the health care providers further means a physician, a psychiatrist, a psychologist, a MSW, a LCSW, a DSW, a public health care employee, a social service agency employee, a physician assistant, a nurse practitioner, and other health care disciplines well known to the health care profession.

3. The method according to claim 1, where the specified hours of operation may be nine a.m. to five p.m, or 7 a.m to 7 p.m., or a twenty-four hour period.

4. The method according to claim 1, where the network-interfaced computing means of the at least one health care provider may be connected to the network-interfaced computing means of the at least one sub-population community member by a specified appointment date and time during the specified hours of operation.

5. The method according to claim 1, where the data stream can include executable installation code for application software on at least one sub-population community member personal computing means, and audio, and video, and photos, and life-episode productions, and FIPS 140-2 encrypted private health care data.

6. The FIPS encrypted private health care data according to claim 5, may further include an at least one member health care prescription, an at least one mental health care referral, an at least one mental health care treatment plan, an at least one member health care personal health care history, an at least one member health care vital statistics and other health care information known to those in the health care profession.

7. The method according to claim 1, wherein the registration further includes: a permission of a sub-community member for an at least one health care provider to establish a secure remote access connection between the network-interfaced computing means of the provider and the member; and the registering user's health insurance information to include confirmation of insurance, health insurance policy number(s) and type of coverages; and user characteristics including an at least one geospatial coordinate, cultural information, first-language of household, corporate membership, or special health care interests; and information about the member computing means IP address.

8. The method according to claim 7, wherein the member can be an individual or an entire household when the household has a group or family health insurance policy.

9. The method according to claim 1, where the secure remote access connection can be established using customized secure remote access software that is appropriate to establish a secure remote access depending on the specific operating systems of the two computing means, or an operating system's integrated secure remote access software that is compatible between the at least one provider computing means and the at least one sub-population community member computing means or a server virtual desktop application.

10. The method according to claim 1, where the network-interfaced website software is installed on an at least one provider network-interfaced computing means, or on a central server interfaced to the other computing means in the network, or on a cloud platform server interfaced to the other computing means in the network.

11. The method according to claim 1, where the health care provider administrator includes at least one of a public health expert, a mental health expert, a psychiatrist, a masters in social work, a doctor in social work, a psychologist, a medical doctor, a physician, a physician's assistant, a nurse practitioner or other health care provider well know to those in the medical profession.

12. The method according to claim 1, where the computing means can be any device that has or interacts with an operating system and processes input-output signals from a video camera and microphone, which includes at least a desktop computer, a laptop computer, a tablet PC, a mobile ‘smart phone’, a netbook computer, a thin client, a dumb client, or other devices.

13. A method for actively providing mental health care access to an entire sub-population community, comprising: a computing network to provide an at least one public health care provider administrated computing network-interfaced website software registration step to assign a new member to an at least one sub-population community; a mental health care provider secure remote access connection to a sub-population community member's computing means during production of a life-episode audio-visual data stream according to a production schedule; a broadcast step from a computing means of the at least one community member to all other sub-population community members computing means according to a broadcast schedule; a storage step of the life-episode data on a computing means memory of the computing network; a network-interfaced website software means for provider authorized downloads of archived life-episode data streams to sub-population community members and providers computing means; a screening step of the life-episode data by an at least one mental health care provider, a transmission step of mental health provider encrypted health care assessments of life-episode data using secure remote access connections between mental health provider computing means and sub-population community member computing means; and a further storage step using network-interfaced computing means memory to store records of communicated mental health provider health care information from an at least one mental health care provider to an at least one sub-population community member.

14. The method according to claim 13, where the at least one mental health care provider is a licensed mental health treatment provider approved for practice in the geographical locations of the sub-population community.

15. The method according to claim 13, where the production schedule is posted on the network website for the sub-population community or sent to sub-population community members using email, or SMS text, or a tweet, or a customized message using secure remote access connectivity.

16. The method according to claim 13, where the broadcast schedule is posted on the network website for the sub-population community or sent to sub-population community members using email, or SMS text, or a tweet, or a customized message using secure remote access connectivity.

17. The method according to claim 13, wherein the registration further includes: a permission of a sub-community member for an at least one mental health care provider to establish a secure remote access connection between the network-interfaced computing means of the provider and the member; and the registering user's health insurance information to include confirmation of insurance, health insurance policy number(s) and type of coverages; and user characteristics including an at least one geospatial coordinate, cultural information, first-language of household, corporate membership, or special health care interests; and information about the member computing means IP address.

18. The method according to claim 17, wherein the member can be an individual or an entire household when the household has a group or family health insurance policy.

19. The method according to claim 13, where the secure remote access connection can be established using customized secure remote access software that is appropriate to establish a secure remote access depending on the specific operating systems of the two computing means, or an operating system's integrated secure remote access software that is compatible between the at least one provider computing means and the at least one sub-population community member computing means or a virtual desktop application.

20. The method according to claim 13, where the network-interfaced website software is installed on an at least one provider network-interfaced computing means, or on a central server interfaced to the other computing means in the network, or on a cloud platform server interfaced to the other computing means in the network.

21. The method according to claim 13, where the life-episode production is created using a protocol agreed upon by the provider and the member.

22. The method according to claim 13, where the mental health provider information may include an at least one mental health care referral, an at least one mental health care treatment plan, an at least one member health care vital statistics and other health care information known to those in the health care profession.

23. The method according to claim 13, where the at least one public health care provider administrator includes at least one of a public health expert, a mental health expert, a psychiatrist, a masters in social work, a doctor in social work, a psychologist, a medical doctor, a physician, a physician's assistant, a nurse practitioner or other health care provider well know to those in the medical profession.

24. The method according to claim 13, where the computing means can be any device that has or interacts with an operating system and processes input-output signals from a video camera and microphone, which includes at least a desktop computer, a laptop computer, a tablet PC, a mobile ‘smart phone’, a netbook computer, a thin client, a dumb client, or other devices.

25. A computer readable medium storing a software program executable on a network-interfaced computing device, the software program comprising data and instructions for: establishing secure remote access between at least one of a health care provider computing means and a sub-population community member computing means; providing a web-based graphical user interface for registration of members into a sub-population community, to include information about a member's health care insurance, and user characteristics, and a unique IP address information about the member's personal computing means, and permissions for secure remote access, and permissions for health care treatments, and permissions for life-episode production and broadcasts; providing a life-episode protocol list and download link for said protocols; providing an archival list and download instructions for archived life-episode productions; providing appointment scheduling information for members of a sub-population community; providing appointment scheduling information for all health care provider administrators for a sub-population community; providing administrative views of sub-population community member profiles; providing member views of sub-population community member profiles; providing a member health insurance billing log; and providing a graphical user interface for means for accepting philanthropic donations for use in health care screenings of sub-population community members without health insurance.
